(19) United States
(12) Patent Application Publication
(10) Pub. No.: US 2020/0229055 A1
(43) Pub. Date: Jul. 16, 2020

(54) BASE STATION AND USER EQUIPMENT FOR MOBILE COMMUNICATION SYSTEM

(71) Applicant: Institute For Information Industry, Taipei (TW)

(72) Inventor: Chun-Che CHIEN, Taipei (TW)

(21) Appl. No.: 16/699,053

(22) Filed: Nov. 28, 2019

Related U.S. Application Data
(60) Provisional application No. 62/791,035, filed on Jan. 11, 2019.

(51) Int. Cl. H04W 36/08; H04W 72/08; H04W 36/00; H04W 36/30; H04W 28/02; H04W 76/27

(52) U.S. Cl. CPC H04W 36/08; H04W 72/085; H04W 76/27; H04W 36/30; H04W 28/0278; H04W 36/0033

(57) ABSTRACT

A base station (BS) and a user equipment (UE) for a mobile communication system are provided. The BS stores a plurality of cellular QoS parameter sets and a plurality of additional vertical-specific information sets. Each of the additional vertical-specific information sets includes periodicity, a traffic arrival pattern and a packet size. The BS generates resource configuration setting information according to at least one of the cellular QoS parameter sets and at least one of the additional vertical-specific information sets associated with a service type of the UE, and transmits the resource configuration setting information to the UE.

### PRIORITY

This application claims priority to U.S. Provisional Patent Application No. 62/791,035 filed on Jan. 11, 2019, which is hereby incorporated by reference in its entirety.

### FIELD

The present invention relates to a base station (BS) and a user equipment (UE) for a mobile communication system, especially for the 5G mobile communication system. More particularly, the BS can generate resource configuration setting information according to the at least one of the cellular Quality of Service (QoS) parameter sets and the at least one of the additional vertical-specific information sets associated with a service type of the UE.

### BACKGROUND

With the rapid development of wireless communication technologies, wireless communication has found wide application in people's life, and people's demand for wireless communication is increasing. The next generation of mobile communication system (which is generally referred to as the 5G mobile communication system currently) has proposed several new service types, e.g., Ultra-reliable and Low Latency Communication (URLLC), Enhanced Mobile Broadband (eMBB) communication, and Massive Machine Type Communication (mMTC).

In addition to the above service types, people in the industry still consider adding other service types in the external heterogeneous system into to the 5G mobile communication system. For example, the traditional industrial communication utilizes the time sensitive networking (TSN) communication standard to perform the Ethernet-based signal transmission. The current industry and academics have been interested in if the TSN system is able to be integrated into the 5G mobile communication system to become a 5G time sensitive communication (TSC) system so as to make the devices of the TSN system communicate with each other through the 5G mobile communication system, especially for the communication between the central control device and the manipulating industrial devices which are remotely distributed.

However, the TSN system and the 5G mobile communication system belong to the wired communication and the wireless communication respectively, and have substantial differences in both use condition and network protocol. Accordingly, how to integrate the TSN system into the 5G mobile communication system is a popular issue in the art.

### SUMMARY

Provided is an integration mechanism to obtain the additional vertical-specific information from the external heterogeneous system (e.g., the TSN system) and provide resource configuration setting information for the UE based on both the inherent cellular QoS parameters and the additional vertical-specific information. Accordingly, the integration mechanism can integrate the external heterogeneous system (e.g., the TSN system) into the 5G mobile communication system to support vertical applications for vertical markets (e.g., automotive, energy, food and agriculture, city management, government, healthcare, manufacturing, and public transportation) so that each vertical application has corresponding performance requirements.

The disclosure includes a base station (BS) for a mobile communication system. The BS comprises a transceiver, a storage and a processor. The storage is configured to store a plurality of cellular QoS parameter sets and a plurality of additional vertical-specific information sets. Each of the additional vertical-specific information sets comprises periodicity of a periodic traffic, a traffic arrival pattern and a packet size. The processor is electrically connected to the transceiver, and configured to execute the following operations: determining that at least one of the cellular QoS parameter sets and at least one of the additional vertical-specific information sets are associated with a service type of a user equipment (UE); generating resource configuration setting information according to the at least one of the cellular QoS parameter sets and the at least one of the additional vertical-specific information sets; and transmitting the resource configuration setting information to the UE.

The disclosure also includes a user equipment (UE) for a mobile communication system. The UE connecting to a BS. The BS stores a plurality of cellular QoS parameter sets and a plurality of additional vertical-specific information sets. Each of the additional vertical-specific information set comprises periodicity of a periodic traffic, a traffic arrival pattern and a packet size. The UE comprises a transceiver and a processor. The processor is electrically connected to the transceiver, and is configured to execute the following operations: determining at least one of service types of the UE; based on the at least one of service types, transmitting at least one of the additional vertical-specific information sets to the BS via the transceiver to make the BS determine that at least one of the cellular QoS parameter sets and the at least one of the additional vertical-specific information sets are associated with a service type of the UE and generate resource configuration setting information according to the at least one of the cellular QoS parameter sets and the at least one of the additional vertical-specific information sets; and receiving the resource configuration setting information from the BS via the transceiver.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts an implementation scenario according to the present invention;

FIG. 2 depicts a schematic view of a QoS profile QP according to the present invention;

FIG. 3 depicts another implementation scenario according to the present invention;

FIG. 4 depicts a schematic view of a QoS profile QP according to the present invention;

FIG. 5 depicts another implementation scenario according to the present invention;

FIG. 6 depicts another implementation scenario according to the present invention;

FIG. 7 depicts another implementation scenario according to the present invention;

FIG. 8 is a schematic view of the BS 1 according to the present invention; and

FIG. 9 is a schematic view of the UE 2 according to the present invention.

### DETAILED DESCRIPTION

In the following description, the present invention will be explained with reference to certain example embodiments thereof. These example embodiments are not intended to limit the present invention to any particular environment, example, embodiment, applications or implementations described in these example embodiments. Therefore, description of these example embodiments is only for purpose of illustration rather than to limit the present invention.

It shall be appreciated that in the following embodiments and the attached drawings, elements unrelated to the present invention are omitted from depiction; and dimensional relationships among individual elements in the attached drawings are illustrated only for ease of understanding, but not to limit the actual scale.

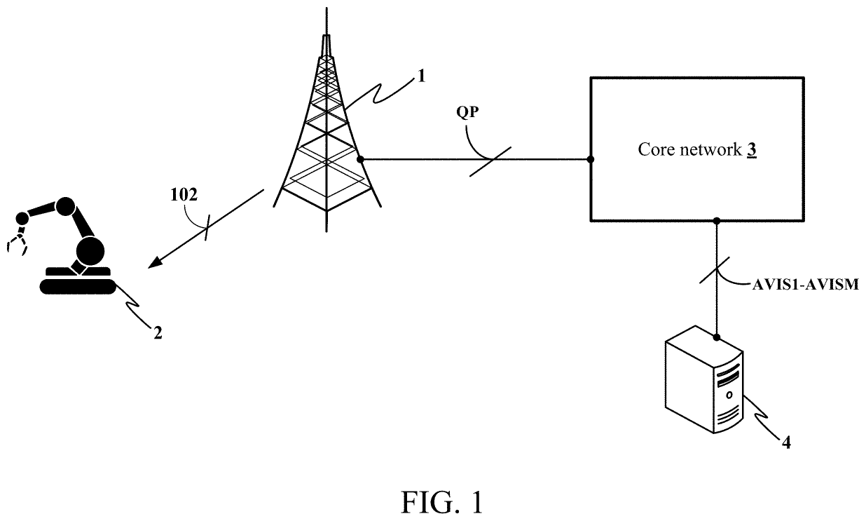

The first embodiment of the present invention is as shown in FIG. 1. FIG. 1 depicts an implementation scenario of the present invention. The present invention relates to a mobile communication system which may be the next generation of mobile communication system (broadly called 5G mobile communication system currently) or any future mobile communication systems developed from the current 5G mobile communication system. The following description is based on the 5G mobile communication system to illustrate the present invention; however, how to extend the technical means of the present invention to be applied to other mobile communication systems shall be appreciated by those of ordinary skill in the art, and thus will be not further described herein.

The mobile communication system of the present invention includes a base station (BS) 1, a user equipment (UE) 2, a core network 3 and a vertical-specific server 4. The vertical-specific server 4 may be the server belonging to an electrical power company for communicating with a plurality of smart meters (e.g., the UE 2), the server belonging to a factory for communicating with a plurality of operating robots (e.g., the UE 2), or the server belonging to any automation industry for communicating with a plurality of devices of any time sensitive communication (TSC) system.

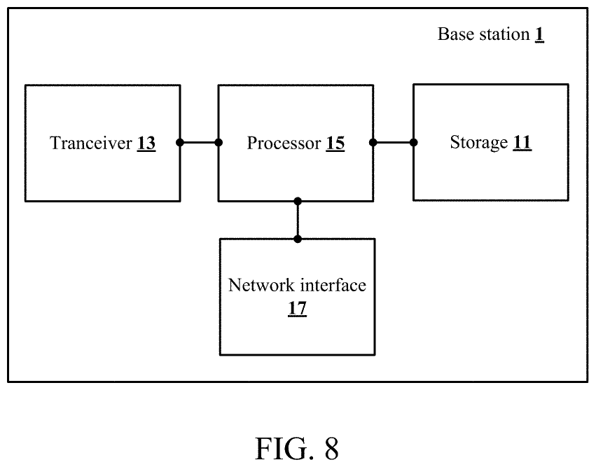

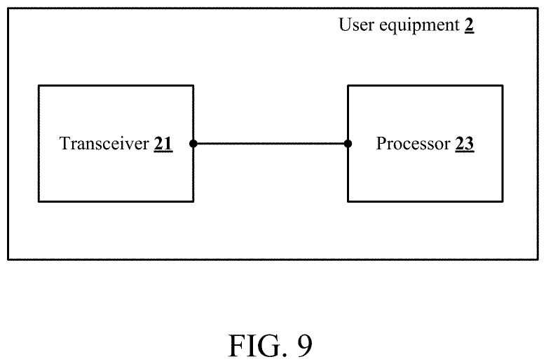

The BS 1 connects to the core network 3 via a wire (e.g., an optical-fiber cable) and the vertical-specific server 4 connect to the core network 3 via the Internet. The UE 2 establishes a wireless connection with the BS 1 for communicating with the vertical-specific server 4 through the BS 1 and the core network 3. In this embodiment, for simplification of the description, only the single BS 1, the single UE 2 and the single vertical-specific server 4 are depicted in FIG. 1, and those of ordinary skill in the art would appreciate that there may be other BSs connecting to the core network 3, other vertical-specific servers connecting to the core network 3, and other UEs connecting to the BS 1. The components and the functions of the components relevant to the BS 1 and UE 2 will be further described in the embodiments corresponding to FIG. 8 and FIG. 9 respectively.

The BS 1 in the 5G mobile communication system is usually called a “gNB.” The BS 1 stores a plurality of cellular QoS parameter sets and a plurality of additional vertical-specific information sets. The cellular QoS parameter sets are inherently defined by the 5G mobile communication system and each cellular QoS parameter set may include the parameters such as the resource type, the default priority level, the packet delay budget, the packet error rate, etc. Each cellular QoS parameter set corresponds to a cellular QoS identifier, e.g., the 5G QoS Identifier (5QI) or the QoS flow identifiers (QFI). The details of the cellular QoS parameter sets and their corresponding cellular QoS identifiers could be referred to the section 5.7.4 of the 3GPP TS 23.501 specification, especially Table 5.7.4-1: Standardized 5QI to QoS characteristics mapping (but not limited thereto).

Each additional vertical-specific information set includes a plurality of pieces of information relating to requirements of the time sensitive communication between the UE 2 and the server 4. The related information may include periodicity of a periodic traffic, a traffic arrival pattern and a packet size. The traffic arrival pattern may include a traffic arrival time and a traffic transmission direction. The traffic transmission direction is one of a downlink (DL) transmission direction, an uplink (UL) transmission direction or a sidelink transmission direction. The traffic arrival time may be indicated by a periodic offset. The periodic offset may be defined with respect to a reference time point (e.g., a margin of a frame, a margin of a slot, a margin of an OFDM symbol). In other words, the additional vertical-specific information sets includes the supplementary information for the BS 2 to configure the uplink and downlink resources and the scheduling parameter (e.g., downlink semi-persistent scheduling (DL SPS) or uplink configured grant (UL CG) configurations) to meet the requirements of time sensitive communication between the UE 2 and the server 4.

The BS 1 determines that at least one of the cellular QoS parameter sets and at least one of the additional vertical-specific information sets are associated with a service type of the UE 2. Next, the BS 1 generates resource configuration setting information 102 according to the at least one of the cellular QoS parameter sets and the at least one of the additional vertical-specific information sets and transmits the resource configuration setting information 102 to the UE 2. Therefore, the UE 2 can perform the downlink and/or uplink transmission with the BS 1 via the over-the-air (OTA) interface (e.g., the Uu interface) according to vertical-specific traffic characteristics and exchange data packet with the server 4 through the BS 1 and the core network 3.

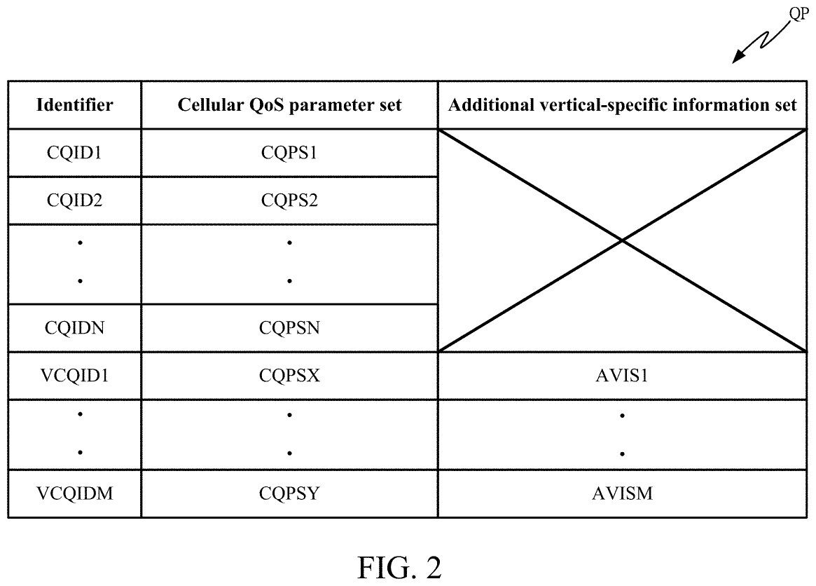

The second embodiment of the present invention is as shown in FIG. 2. The second embodiment is an extension of the first embodiment. FIG. 2 depicts a schematic view of a QoS profile QP of the present invention. The BS 1 stores the QoS profile QP. The QoS profile QP describes a plurality of cellular QoS identifiers CQID1-CQIDN (where N is a positive integer), a plurality of vertical-specific QoS identifiers VCQID1-VCQIDM (where M is a positive integer), the cellular QoS parameter sets CQPS1-CQPSN (including the cellular QoS parameter sets CQPSX and CQPSX), and the additional vertical-specific information sets AVIS1-AVISM.

As shown in FIG. 2, each of the cellular QoS identifiers CQID1-CQIDN corresponds to one of the cellular QoS parameter sets CQPS1-CQPSN, and each of the vertical-specific QoS identifiers VCQID1-VCQIDM corresponds to one of the cellular QoS parameter sets CQPS1-CQPSN and one of the additional vertical-specific information sets AVIS1-AVISM. Specifically, the cellular QoS identifiers CQID1-CQIDN correspond to the cellular QoS parameter sets CQPS1-CQPSN, respectively, and the vertical-specific QoS identifiers VCQID1-VCQIDM corresponds to the additional vertical-specific information sets AVIS1-AVISM.

Moreover, each of the vertical-specific QoS identifiers VCQID1-VCQIDM corresponds to one of the cellular QoS parameter sets CQPS1-CQPSN, e.g., the vertical-specific QoS identifier VCQID1 corresponds to the cellular QoS parameter set CQPSX (which is one of the cellular QoS parameter sets CQPS1-CQPSN) and the vertical-specific QoS identifier VCQIDM corresponds to the cellular QoS parameter set CQPSY (which is one of the cellular QoS parameter sets CQPS1-CQPSN). In addition, different vertical-specific QoS identifiers may corresponds to the same cellular QoS parameter set, e.g., the cellular QoS parameter set CQPSX may be identical to or different from the cellular QoS parameter set CQPSY.

As aforementioned, the cellular QoS parameter sets are inherently defined by the 5G mobile communication system and the cellular QoS identifiers may be the 5G QoS Identifiers (5QIs). To make the BS 1 able to generate the appropriate resource configuration setting information according to the QoS profile QP for supporting the time sensitive communication between the UE 2 and the server 4, the present invention adds the additional vertical-specific information sets AVIS1-AVISM and their corresponding cellular QoS parameter sets and additional vertical-specific information sets into the QoS profile QP, and assigns each of them with a new ID (i.e., the vertical-specific QoS identifier).

The QoS profile QP may be provided by the SMF (Session Management Function) of the core network 3 to the base station 1 via the AMF (Access and Mobility Management Function) over the N2 reference point, or may be preconfigured in the BS 1. Since the core network 3 connects to the vertical-specific server 4, the core network 3 will generates the QoS profile QP according to the information (e.g., the additional vertical-specific information sets AVIS1-AVISM) received from the vertical-specific server 4 and transmits the QoS profile QP including the vertical-specific QoS identifiers VCQID1-VCQIDM and the additional vertical-specific information sets AVIS1-AVISM to the BS 1.

Afterwards, the BS 1 receives at least one of the vertical-specific QoS identifiers VCQID1-VCQIDM from the core network 3. The at least one of the vertical-specific QoS identifiers VCQID1-VCQIDM corresponds to the at least one of the cellular QoS parameter sets CQPS1-CQPSN and the at least one of the additional vertical-specific information sets AVIS1-AVISM. By this way, the BS 1 determines that the at least one of the cellular QoS parameter sets CQPS1-CQPSN and the at least one of the additional vertical-specific information sets AVIS1-AVISM are associated with the service type of the UE 2 so as to generate the resource configuration setting information 102.

For example, the BS 1 may receive at least one QoS flow identifier (ID) from the core network 3 and consequently determine which vertical-specific QoS identifier each QoS flow identifier corresponds to. Thus, based on the corresponding vertical-specific QoS identifier(s), the BS 1 can learn one or more associated cellular QoS parameter sets and one or more associated additional vertical-specific information sets for generating the resource configuration setting information 102.

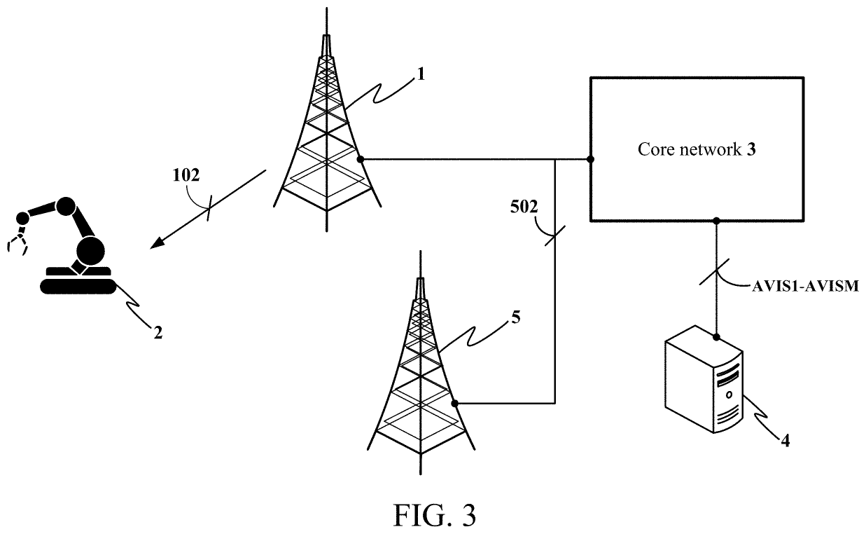

The third embodiment of the present invention is as shown in FIG. 3. The third embodiment is an extension of the second embodiment. FIG. 3 depicts another implementation scenario of the present invention. In this embodiment, another BS 5 also connects to the the core network 3 and connects to the BS 1 (via the core network 3 or directly). In a situation that the UE 2 performs a handover from the BS 5 to the BS 1, the BS 1 receives a handover message 502 including at least one of the vertical-specific QoS identifiers from the BS 5 (e.g., via the Xn interface). Similarly, the at least one of the vertical-specific QoS identifiers VCQID1-VCQIDM corresponds to the at least one of the cellular QoS parameter sets CQPS1-CQPSN and the at least one of the additional vertical-specific information sets AVIS1-AVISM. By this way, when the UE 2 handovers from the BS 5 to the BS 1, the BS 5 can quickly learn the at least one of the cellular QoS parameter sets CQPS1-CQPSN and the at least one of the additional vertical-specific information sets AVIS1-AVISM associated with the service type of the UE 2 in response to the reception of the handover message 502 so as to generate the resource configuration setting information 102.

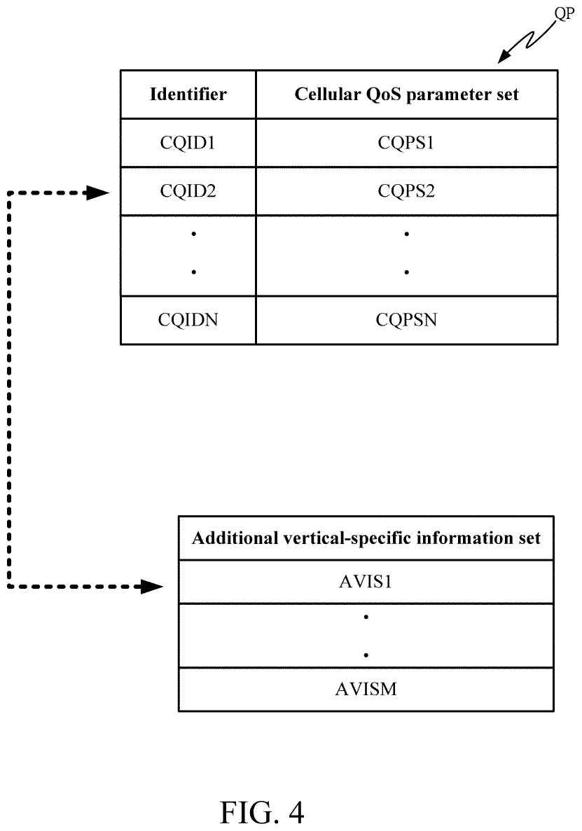

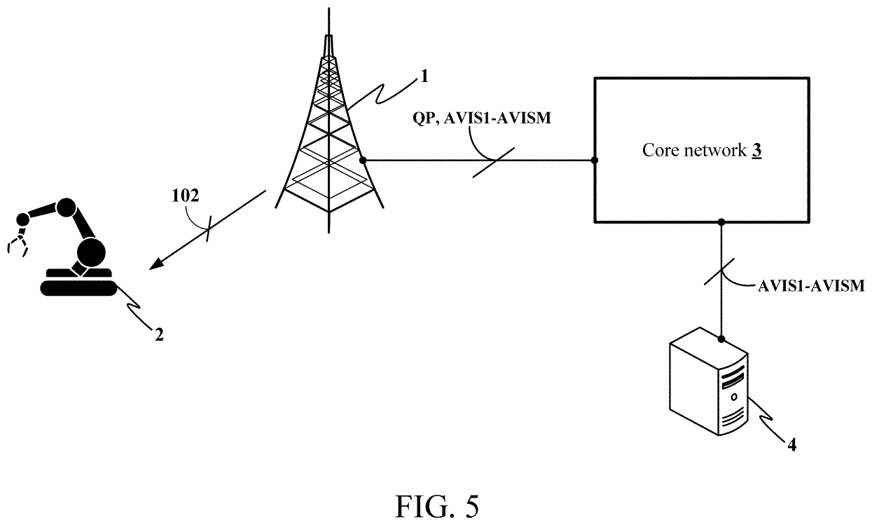

The fourth embodiment of the present invention is as shown in FIGS. 4 and 5. The fourth embodiment is an extension of the first embodiment. FIG. 4 depicts a schematic view of a QoS profile QP of the present invention. The QoS profile QP describes a plurality of cellular QoS identifiers CQID1-CQIDN (where N is a positive integer) and the cellular QoS parameter sets CQPS1-CQPSN (where M is a positive integer). Each of the cellular QoS identifiers CQID1-CQIDN corresponding to one of the cellular QoS parameter sets CQPS1-CQPSN.

In this embodiment, the additional vertical-specific information sets AVIS1-AVISM are not merged into the QoS profile QP. Instead, each of the additional vertical-specific information sets AVIS1-AVISM provides assistance information corresponding to one of the cellular QoS parameter sets CQPS1-CQPSN. Thus, the BS 1 receives the QoS profile QP and the additional vertical-specific information sets AVIS1-AVISM from the core network 3.

Each of association between one of the additional vertical-specific information sets AVIS1-AVISM and one of the cellular QoS parameter sets CQPS1-CQPSN may be derived from the QoS flow identifier (QFI). In other words, each of the additional vertical-specific information sets AVIS1-AVISM may be cooperated with one of the cellular QoS parameter sets CQPS1-CQPSN. For example, as shown in FIG. 4, the additional vertical-specific information set AVIS1 may correspond to the cellular QoS parameter set CQPS2.

Please also refer to FIG. 3 for the fifth embodiment of the present invention. The fifth embodiment is an extension of the fourth embodiment. Similarly, in a situation that the UE 2 performs a handover from the BS 5 to the BS 1, the BS 1 receives the handover message 502. However, different from the third embodiment, the handover message 502 in this embodiment includes the at least one of the additional vertical-specific information sets AVIS1-AVISM. By this way, when the UE 2 handovers from the BS 5 to the BS 1, the BS 5 can quickly learn the at least one of the cellular QoS parameter sets CQPS1-CQPSN and the at least one of the additional vertical-specific information sets AVIS1-AVISM associated with the service type of the UE 2 in response to the reception of the handover message 502 so as to generate the resource configuration setting information 102.

Please also refer to FIG. 1 and FIG. 5 for the sixth embodiment of the present invention. In this embodiment, the core network 3 receives the additional vertical-specific information sets AVIS1-AVISM from the vertical-specific server 4, and the BS 1 receives the additional vertical-specific information sets AVIS1-AVISM (included in the QoS profile QP as shown in FIG. 1 or separate from the QoS profile QP as shown in FIG. 5) from the core network 3.

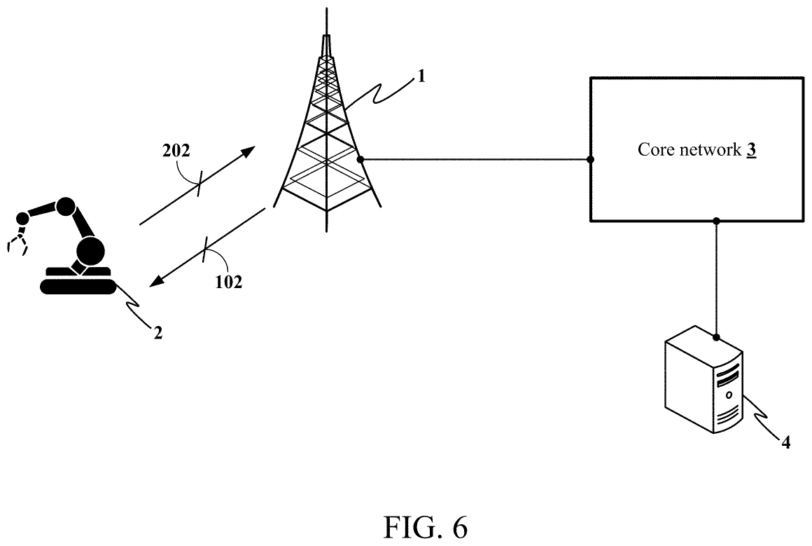

The seventh embodiment of the present invention is as shown in FIG. 6. In this embodiment, the UE 2 determines that one or more additional vertical-specific information sets AVIS1-AVISM are relevant to its service type. Next, the UE 2 generates a report message 202 to carry the at least one of the additional vertical-specific information sets AVIS1-AVISM and transmits the report message 202 to the BS 1.

Afterwards, the BS 1 receive the report message 202 including the at least one of the additional vertical-specific information sets from the UE 2. For example, the report message 202 may be a radio resource control (RRC) message. Therefore, the BS 1 can learn the at least one of the cellular QoS parameter sets CQPS1-CQPSN and the at least one of the additional vertical-specific information sets AVIS1-AVISM associated with the service type of the UE 2 so as to generate the resource configuration setting information 102.

In other embodiments, the UE 2 further receives the additional vertical-specific information sets AVIS1-AVISM from the BS 1. Based on the additional vertical-specific information sets AVIS1-AVISM, the UE 2 can learn that at least one of the additional vertical-specific information sets AVIS1-AVISM is relevant to its service type.

In other embodiments, the UE 2 further receives the vertical-specific QoS identifiers VCQID1-VCQIDM from the BS 1. Based on the vertical-specific QoS identifiers VCQID1-VCQIDM, the UE 2 can learn that at least one of the additional vertical-specific information sets AVIS1-AVISM is relevant to its service type.

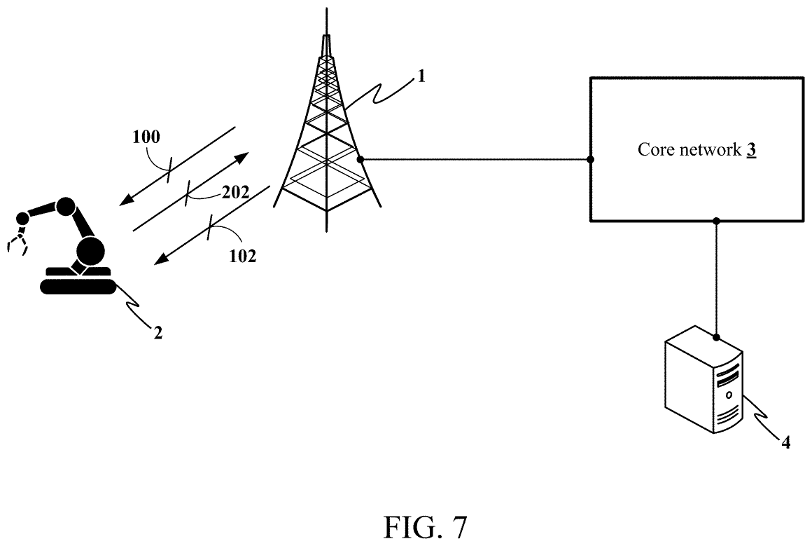

The eighth embodiment of the present invention is as shown in FIG. 7. The eighth embodiment is an extension of the seventh embodiment. In this embodiment, the BS 1 transmits an assistance information request message 100 to the UE 2. After receiving the assistance information request message 100, the UE 2 generates the report message 202 including assistance information element (IE) defining the at least one of the additional vertical-specific information sets AVIS1-AVISM in response to the assistance information request message 100. Afterwards, the UE 2 transmits the report message 202 to the BS 1.

In other embodiments, the at least one of the additional vertical-specific information sets AVIS1-AVISM may be carried in a medium access control control element (MAC CE) of the report message 202. The MAC CE may be a newly designed MAC CE or a MAC CE modified from the MAC CE used for carrying a buffer status report (i.e., the MAC CE carries both the buffer status report and the at least one of the additional vertical-specific information sets AVIS1-AVISM).

A ninth embodiment of the present invention is as shown in FIG. 8, which is a schematic view of the BS 1 according to the present invention. The BS 1 comprises a storage 11, a transceiver 13, a processor 15 and a network interface 17. The processor 15 is electrically connected to the storage 11, the transceiver 13 and the network interface 17. It shall be appreciated that, for simplifying the description, other components of the BS 1 such as the housing, the power supply module and other components irrelevant to the present invention are omitted from depiction in the drawings. The processor 15 may be any of various processors, Central Processing Units (CPUs), microprocessors, digital signal processors, or other computing devices known to those of ordinary skill in the art.

Corresponding to the first embodiment, the network interface 17 connects to a core network (e.g., the core network 3), and the storage 11 stores a plurality of cellular QoS parameter sets and a plurality of additional vertical-specific information sets. Each of the additional vertical-specific information sets comprises periodicity of a periodic traffic, a traffic arrival pattern and a packet size. The processor 15 determines that at least one of the cellular QoS parameter sets and at least one of the additional vertical-specific information sets are associated with a service type of a user equipment (UE) (e.g., the UE 2).

Afterwards, the processor 15 generates resource configuration setting information according to the at least one of the cellular QoS parameter sets and the at least one of the additional vertical-specific information sets. Next, the processor 15 transmits the resource configuration setting information to the UE.

Corresponding to the second embodiment, the storage 11 stores a QoS profile. The QoS profile describes a plurality of cellular QoS identifiers, a plurality of vertical-specific QoS identifiers, the cellular QoS parameter sets and the additional vertical-specific information sets. Each of the cellular QoS identifiers corresponds to one of the cellular QoS parameter sets, and each of the vertical-specific QoS identifiers corresponds to one of the cellular QoS parameter sets and one of the additional vertical-specific information sets. In addition, since the core network connects to a vertical-specific server, the processor 15 receives the at least one of the vertical-specific QoS identifiers from the core network via the network interface 17. The at least one of the vertical-specific QoS identifiers corresponds to the at least one of the cellular QoS parameter sets and the at least one of the additional vertical-specific information sets.

Corresponding to the third embodiment, the network interface 17 further connects to another BS (e.g., the BS 5), and the processor 15 receives a handover message including at least one of the vertical-specific QoS identifiers from the another BS via the network interface 17 when the UE performs a handover from the another BS to the BS 1. The at least one of the vertical-specific QoS identifiers corresponds to the at least one of the cellular QoS parameter sets and the at least one of the additional vertical-specific information sets.

Corresponding to the fourth embodiment, the storage 11 stores a QoS profile. The QoS profile describes a plurality of cellular QoS identifiers and the cellular QoS parameter sets. Each of the cellular QoS identifiers corresponds to one of the cellular QoS parameter sets, and each of the additional vertical-specific information sets provides assistance information corresponding to one of the cellular QoS parameter sets.

Corresponding to the fifth embodiment, the network interface is further configured to connect to another BS (e.g., the BS 5), and the processor 15 receives a handover message including the at least one of the additional vertical-specific information sets from the another BS via the network interface when the UE performs a handover from the another BS to the BS 1.

Corresponding to the sixth embodiment, the core network (e.g., the core network 3) connects to a vertical-specific server (e.g., the vertical-specific server 4). The core network receives the additional vertical-specific information sets from the vertical-specific server, and the processor 15 receives the at least one of the additional vertical-specific information sets from the core network via the network interface 17.

Corresponding to the seventh embodiment, the processor 15 receives a report message including the at least one of the additional vertical-specific information sets from the UE via the transceiver 13.

Corresponding to the eighth embodiment, the processor 15 transmits an assistance information request message to the UE so that the UE generates the report message including assistance information element (IE) defining the at least one of the additional vertical-specific information sets in response to the assistance information request message and transmits the report message to the BS. Moreover, the report message may be a radio resource control (RRC) message.

In one embodiment, the processor 15 receives the at least one of the additional vertical-specific information sets carried in a medium access control control element (MAC CE) of the report message from the UE via the transceiver 13. In one embodiment, the MAC CE further carries a buffer status report.

In one embodiment, the traffic arrival pattern of each of the additional vertical-specific information sets further comprises a traffic arrival time and a traffic transmission direction. Furthermore, in other embodiments, the traffic transmission direction is one of a downlink transmission direction, an uplink transmission direction or a sidelink transmission direction.

In one embodiment, the processor 15 further transmits the additional vertical-specific information sets to the UE via the transceiver 13.

A tenth embodiment of the present invention is as shown in FIG. 9, which is a schematic view of the UE 2 according to the present invention. The UE 2 connects to a BS (e.g., the BS 1). The BS stores a plurality of cellular QoS parameter sets and a plurality of additional vertical-specific information sets. Each of the additional vertical-specific information sets comprises periodicity, a traffic arrival pattern and a packet size. The UE 2 comprises a transceiver 21 and a processor 23. The processor 23 is electrically connected to the transceiver 21. For simplifying the description, other components of the UE 2 such as the storage, the housing, the power supply module and other components that are less relevant to the present invention are omitted from depiction in the drawings. The processor 23 may be any of various processors, Central Processing Units (CPUs), microprocessors, digital signal processors, or other computing devices known to those of ordinary skill in the art.

Corresponding to the seventh embodiment, the processor 23 determines at least one of service types of the UE. Next, based on the at least one of service types, the processor 23 transmits at least one of the additional vertical-specific information sets (which may be included in a report message) to the BS via the transceiver 21 to make the BS determine that at least one of the cellular QoS parameter sets and the at least one of the additional vertical-specific information sets are associated with a service type of the UE and generate resource configuration setting information according to the at least one of the cellular QoS parameter sets and the at least one of the additional vertical-specific information set. Afterwards, the processor 23 receives the resource configuration setting information from the BS via the transceiver 21.

In one embodiment, the processor 23 further receives the additional vertical-specific information sets from the base station via the transceiver 21.

In one embodiment, the processor 23 further receives the vertical-specific QoS identifiers from the base station via the transceiver 21.

Corresponding to the eighth embodiment, the processor 23 further receives an assistance information request message from the BS via the transceiver, generates a report message including assistance information element (IE) defining the at least one of the additional vertical-specific information sets in response to the assistance information request message, and transmits the report message to the BS via the transceiver. As aforementioned, the report message may be an RRC message.

In one embodiment, the processor 23 further generates a report message including an MAC CE which carries the at least one of the additional vertical-specific information sets, and transmits the report message to the BS via the transceiver 21. In another embodiment, the MAC CE further carries a buffer status report.

According to the above descriptions, the BS of the present invention is able to obtain the additional vertical-specific information from the external heterogeneous system (e.g., the TSN system) and provide resource configuration setting information for the UE based on both the inherent cellular QoS parameters and the additional vertical-specific information. Accordingly, the present invention can integrate the external heterogeneous system (e.g., the TSN system) into the 5G mobile communication system to support vertical applications.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station (BS) for a mobile communication system, comprising:
a transceiver;
a network interface, being configured to connect to a core network;
a storage, being configured to store a plurality of cellular QoS parameter sets and a plurality of additional vertical-specific information sets, each of the additional vertical-specific information sets comprising periodicity of a periodic traffic, a traffic arrival pattern and a packet size; and
a processor electrically connected to the transceiver, being configured to execute the following operations:
determining that at least one of the cellular QoS parameter sets and at least one of the additional vertical-specific information sets are associated with a service type of a user equipment (UE);
generating resource configuration setting information according to the at least one of the cellular QoS parameter sets and the at least one of the additional vertical-specific information sets; and
transmitting the resource configuration setting information to the UE.

2. The base station of claim 1, wherein the storage stores a QoS profile, the QoS profile describes a plurality of cellular QoS identifiers, a plurality of vertical-specific QoS identifiers, the cellular QoS parameter sets and the additional vertical-specific information sets, each of the cellular QoS identifiers corresponds to one of the cellular QoS parameter sets, and each of the vertical-specific QoS identifiers corresponds to one of the cellular QoS parameter sets and one of the additional vertical-specific information sets.

3. The base station of claim 2, wherein the network interface is further configured to connect to another BS, and the processor receives a handover message including at least one of the vertical-specific QoS identifiers from the another BS via the network interface when the UE performs a handover from the another BS to the BS, and the at least one of the vertical-specific QoS identifiers corresponds to the at least one of the cellular QoS parameter sets and the at least one of the additional vertical-specific information sets.

4. The base station of claim 2, wherein the core network connects to a vertical-specific server, and the processor receives at least one of the vertical-specific QoS identifiers from the core network via the network interface, and the at least one of the vertical-specific QoS identifiers corresponds to the at least one of the cellular QoS parameter sets and the at least one of the additional vertical-specific information sets.

5. The base station of claim 1, wherein the storage stores a QoS profile, the QoS profile describes a plurality of cellular QoS identifiers and the cellular QoS parameter sets, each of the cellular QoS identifiers corresponds to one of the cellular QoS parameter sets, and each of the additional vertical-specific information sets provides assistance information corresponding to one of the cellular QoS parameter sets.

6. The base station of claim 5, wherein the network interface is further configured to connect to another BS, and the processor receives a handover message including the at least one of the additional vertical-specific information sets from the another BS via the network interface when the UE performs a handover from the another BS to the BS.

7. The base station of claim 1, wherein the core network connects to a vertical-specific server, the core network receives the additional vertical-specific information sets from the vertical-specific server, and the processor receives the at least one of the additional vertical-specific information sets from the core network via the network interface.

8. The base station of claim 1, wherein the processor receives a report message including the at least one of the additional vertical-specific information sets from the UE via the transceiver.

9. The base station of claim 8, wherein the processor transmits an assistance information request message to the UE so that the UE generates the report message including assistance information element (IE) defining the at least one of the additional vertical-specific information sets in response to the assistance information request message and transmits the report message to the BS, and the report message is a radio resource control (RRC) message.

10. The base station of claim 8, wherein the processor receives the at least one of the additional vertical-specific information sets carried in a medium access control control element (MAC CE) of the report message from the UE via the transceiver.

11. The base station of claim 10, wherein the MAC CE further carries a buffer status report.

12. The base station of claim 1, wherein the traffic arrival pattern of each of the additional vertical-specific information sets further comprises a traffic arrival time and a traffic transmission direction.

13. The base station of claim 12, wherein the traffic transmission direction is one of a downlink transmission direction, an uplink transmission direction or a sidelink transmission direction.

14. The base station of claim 1, wherein the processor further transmits the additional vertical-specific information sets to the UE via the transceiver.

15. A user equipment (UE) for a mobile communication system, the UE connecting to a BS, the BS storing a plurality of cellular QoS parameter sets and a plurality of additional vertical-specific information sets, each of the additional vertical-specific information sets comprising periodicity of a periodic traffic, a traffic arrival pattern and a packet size, the UE comprising:
a transceiver;
a processor electrically connected to the transceiver, being configured to execute the following operations:
determining at least one of service types of the UE;
based on the at least one of service types, transmitting at least one of the additional vertical-specific information sets to the BS via the transceiver to make the BS determine that at least one of the cellular QoS parameter sets and the at least one of the additional vertical-specific information sets are associated with a service type of the UE and generate resource configuration setting information according to the at least one of the cellular QoS parameter sets and the at least one of the additional vertical-specific information sets; and
receiving the resource configuration setting information from the BS via the transceiver.

16. The user equipment of claim 15, wherein the processor further receives the additional vertical-specific information sets from the base station via the transceiver.

17. The user equipment of claim 15, wherein the processor further receives the vertical-specific QoS identifiers from the base station via the transceiver.

18. The user equipment of claim 15, wherein the processor further receives an assistance information request message from the BS via the transceiver, generates a report message including assistance information element (IE) defining the at least one of the additional vertical-specific information sets in response to the assistance information request message, and transmits the report message to the BS via the transceiver, and the report message is an RRC message.

19. The user equipment of claim 15, wherein the processor further generates a report message including an MAC CE which carries the at least one of the additional vertical-specific information sets, and transmits the report message to the BS via the transceiver.

20. The user equipment of claim 19, wherein the MAC CE further carries a buffer status report.
